(19) United States
(12) Patent Application Publication
(10) Pub. No.: US 2006/0184474 A1
(43) Pub. Date: Aug. 17, 2006

(54) Data analysis apparatus, data analysis program, and data analysis method

(75) Inventors: Hisaaki Hatano, Kawasaki-shi (JP); Kazuto Kubota, Kawasaki-shi (JP); Chie Morita, Yokohama-shi (JP); Akihiko Nakase, Tokyo (JP); Tsuneo Watanabe, Tokyo (JP)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: Kabushiki Kaisha Toshiba, Minato-ku (JP)

(21) Appl. No.: 11/289,673

(22) Filed: Nov. 29, 2005

(30) Foreign Application Priority Data
Nov. 30, 2004 (JP) 2004-346716

(51) Int. Cl. G06F 15/18

(52) U.S. Cl. 706/20

(57) ABSTRACT

There is provided with a data analysis method including: reading out, from a database which is a set of records each including plural explanation variables and a target variable, the target variables of the records; generating a first plurality of clusters based on the read target variables of the records; determining to which cluster each record belongs; generating a classification rule for predicting a cluster from explanation variables; storing the generated classification rule; selecting an explanation variable referred to in the generated classification rule; storing the selected explanation variable in an explanation variable list; and generating a second plurality of clusters based on explanation variables in the records on the explanation variable list and the target variables of the records.

### CROSS-REFERENCE TO RELATED APPLICATIONS

This application claims the benefit of priority under 35USC § 119 to Japanese Patent Application No. 2004-346716 filed on Nov. 30, 2004, the entire contents of which are incorporated herein by reference.

### BACKGROUND OF THE INVENTION

1. Field of the Invention

The present invention relates to a data analysis apparatus, a data analysis program, and a data analysis method.

2. Related Art

Many cases have been reported in which data mining technology is used to analyze discrete information such as customer information. On the other hand, there is a growing need for analyzing numerical information such as sensory data at factories. If numerical data to be analyzed is multidimensional and highly nonlinear, it is difficult to achieve accurate function approximation. In such circumstances, techniques for analysis of discrete data are used, such those generating classification rules such as decision trees.

To generate classification rules for numerical data, the numerical data must be discretized by clustering. Especially if a target variable (variable to be predicted) is a numerical value, discretization is applied before the generation of a classification rule. Discretization of a target variable performed before the generation of a classification rule significantly affects the classification rule being generated. Inappropriate discretization may lead to an unnecessarily complex classification rule or reduced accuracy of classification. If a-priori knowledge about a target variable is available or if a boundary for discretization is obvious from the frequency distribution of the target variable, appropriate discretization can be performed before the generation of a classification rule. However, in most cases such a-priori knowledge or obvious data distribution is not found. Therefore, typically, determination had to be made from a generated classification rule as to whether appropriate discretization was made. That is, it was difficult to generate a readable, simple classification rule because the readability and optimality of a generated classification rule is uncertain at a time of performing discretization.

### SUMMARY OF THE INVENTION

According to an aspect of the present invention, there is provided with a data analysis apparatus comprising: a database which is a set of records each including plural explanation variables and a target variable; a cluster generating unit which generates a plurality of clusters based on the target variables of the records; a determining unit which determines to which cluster each of the records belongs; a classification rule generating unit which generates a classification rule for predicting a cluster from explanation variables; a classification rule storage unit which stores the generated classification rule; an explanation variable selecting unit which selects an explanation variable referred to in the generated classification rule; and an explanation variable list which stores the selected explanation variable; wherein the cluster generating unit generates a plurality of clusters based on explanation variables in the records on the explanation variable list and the target variables of the records.

According to an aspect of the present invention, there is provided with a data analysis program for inducing a computer to execute: reading out, from a database which is a set of records each including plural explanation variables and a target variable, the target variables of the records; generating a first plurality of clusters based on the read target variables of the records; determining to which cluster each record belongs; generating a classification rule for predicting a cluster from explanation variables; storing the generated classification rule; selecting an explanation variable referred to in the generated classification rule; storing the selected explanation variable in an explanation variable list; and generating a second plurality of clusters based on explanation variables in the records on the explanation variable list and the target variables of the records.

According to an aspect of the present invention, there is provided with a data analysis method comprising: reading out, from a database which is a set of records each including plural explanation variables and a target variable, the target variables of the records; generating a first plurality of clusters based on the read target variables of the records; determining to which cluster each record belongs; generating a classification rule for predicting a cluster from explanation variables; storing the generated classification rule; selecting an explanation variable referred to in the generated classification rule; storing the selected explanation variable in an explanation variable list; and generating a second plurality of clusters based on explanation variables in the records on the explanation variable list and the target variables of the records.

### BRIEF DESCRIPTION OF THE DRAWINGS

FIG. 1 is a block diagram schematically showing a configuration of a data analysis apparatus according to an embodiment of the present invention;

FIG. 2 shows by way of an example a part of data to be analyzed;

FIG. 3 shows a part of a data table in which target variables Y in the data to be analyzed is replaced with variables Y(1) indicating a cluster number;

FIG. 4 is a histogram of the frequencies of occurrence of clusters in the data table in FIG. 3;

FIG. 5 shows a part of a generated decision tree;

FIG. 6 shows a result of clustering based on a two-dimensional variable;

FIG. 7 shows a part of data table in which target variables Y in the data to be analyzed is replaced with variables Y(2) indicating a cluster number;

FIG. 8 is a histogram of the frequencies of occurrence of clusters in FIG. 6 as to the data table in FIG. 7;

FIG. 9 shows a part of a generated decision tree; and

FIG. 10 is a flowchart showing a process flow by the data analysis apparatus in FIG. 1.

### DETAILED DESCRIPTION OF THE INVENTION

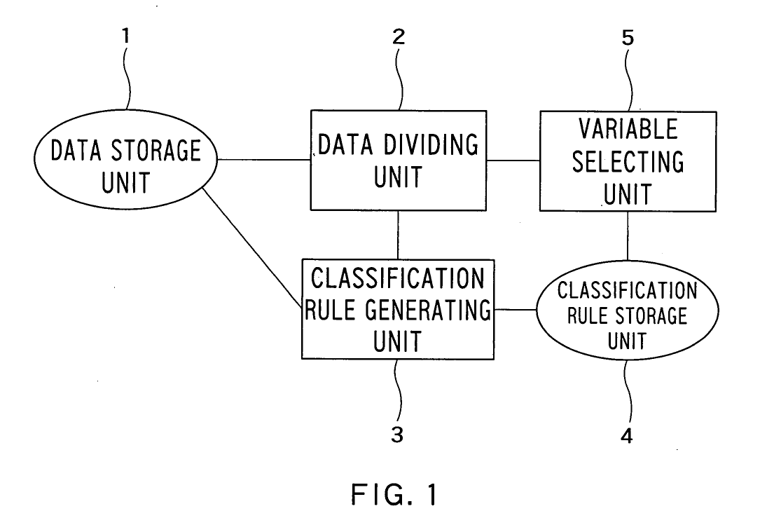

FIG. 1 is a block diagram schematically showing a configuration of a data analysis apparatus according to an embodiment of the present invention.

A data storage unit 1 stores data to be analyzed (database).

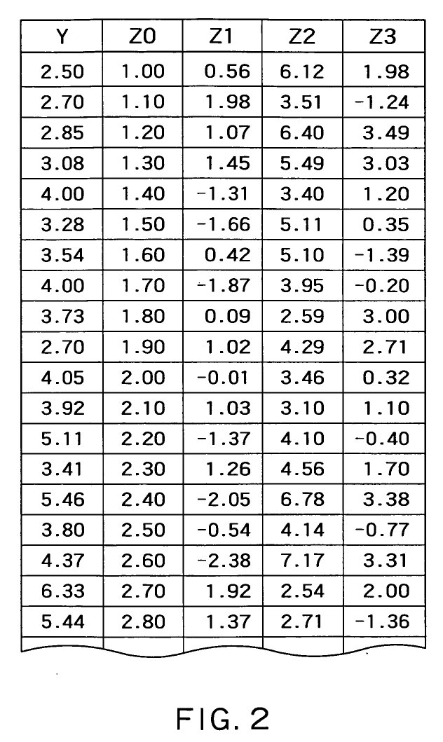

FIG. 2 shows by way of example a part of data to be analyzed.

The data to be analyzed is a set of records each including a target variable Y, and four explanation variables Z0, Z1, Z2, and Z3. All of the variables are numerical data. One row of data represents one record.

A data dividing unit 2 performs clustering on the basis of the data to be analyzed.

The data dividing unit 2 first focuses only on the target variables Y and performs one-dimensional clustering (only the variables Y is subjected to the clustering). The clustering can be accomplished by partitioning each target variable Y into ranges or by using a K-means algorithm.

It is assumed here that the K-means algorithm was applied to the data to be analyzed shown in FIG. 2 to generate five clusters: Cluster 0 [−∞-2.73], Cluster 1 [2.73-4.06], Cluster 2 [4.06-6.35], Cluster 3 [6.35-8.47], and Cluster 4 [8.47-+∞]. The numeric values in the brackets are values of Y. For example, Y greater than or equal to 2.73 and less than 4.06 are classified into Cluster 1 and Y greater than or equal to 4.06 and less than 6.35 are classified into Cluster 2.

The data dividing unit 2 determines the cluster number of each record in the data to be analyzed, on the basis of the clusters thus generated and the target variables Y.

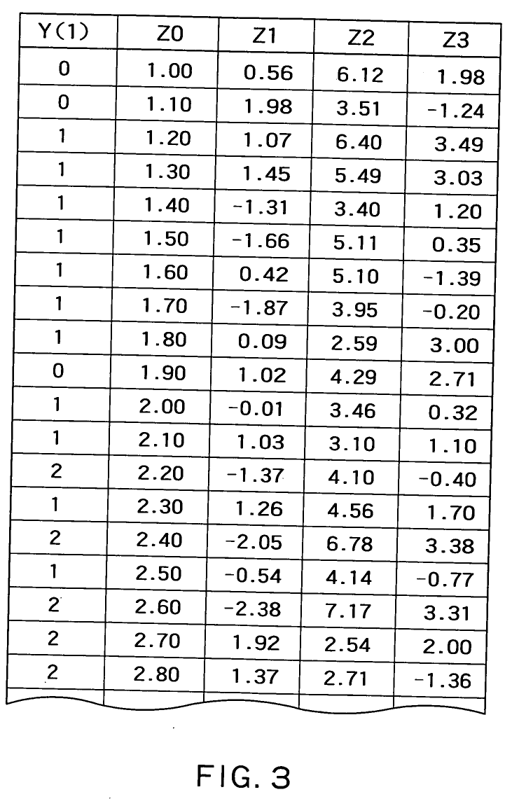

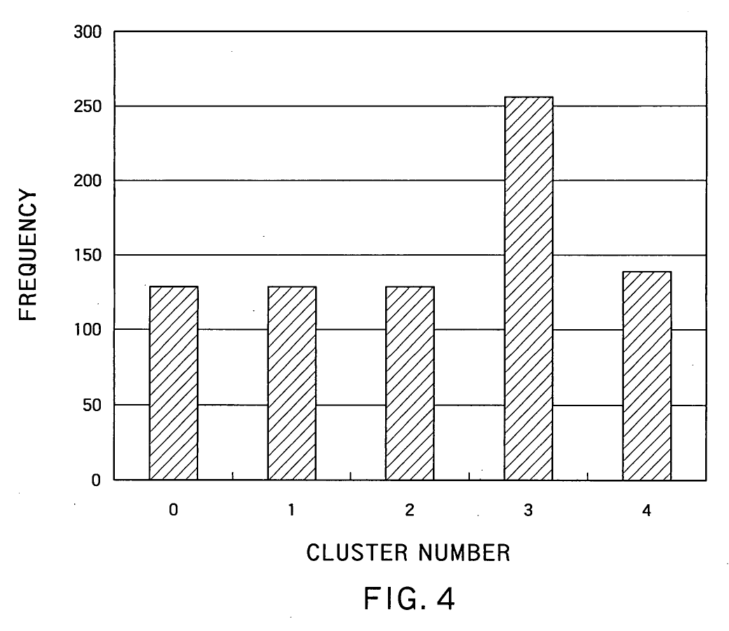

FIG. 3 shows a part of a data table in which the target variables Y in the data to be analyzed is replaced with variables Y(1) indicating a cluster number. The data table is generated by the data dividing unit 2 and stored in the data storage unit 1. FIG. 4 shows a histogram of the frequency of occurrence of the clusters.

A classification rule generating unit 3 regards a variable Y(1) as a target variable and generates a decision tree. That is, the classification rule generating unit 3 generates a decision tree for predicting a cluster number from explanation variables. The classification rule generated is not limited to a decision tree; other classification rules may be generated.

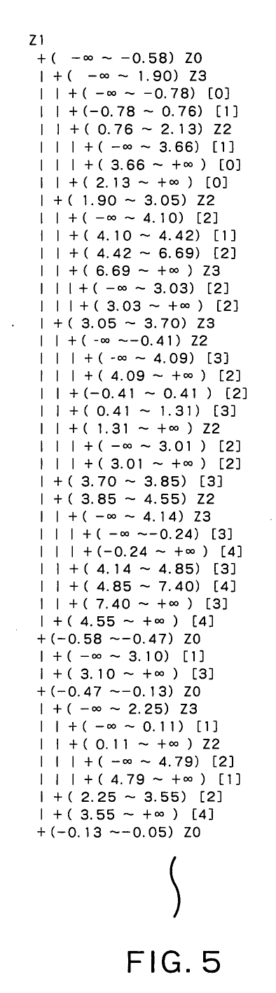

FIG. 5 shows a part of a decision tree generated by the classification rule generating unit 3.

The decision tree is a large one including about 250 leaf nodes. An example of reading of the decision tree will be briefly described. If explanation variable Z1 is less than −0.58, explanation variable Z0 is less than 1.90, and explanation variable Z3 is less than −0.78, case example is classified into Cluster 0. If explanation variable Z1 is greater than or equal to −0.58 and less than −0.47 and explanation variable Z0 is less than 3.10, case example is classified into Cluster 1.

The classification rule generating unit 3 stores the generated decision tree into a classification rule storage unit 4.

A variable selecting unit 5 selects an effective variable for clustering from the decision tree stored in the classification rule storage unit 4. An effective variable may be a variable appearing at the root in the decision tree (root node), or the variable that is most frequently referred to in the decision tree for the data in FIG. 2 or 3 etc. except previously selected explanation variable(s). In this example, the variable selecting unit 5 selects “Z1” which appears at the root as the effective variable and outputs the selected variable Z1 to the data dividing unit 2.

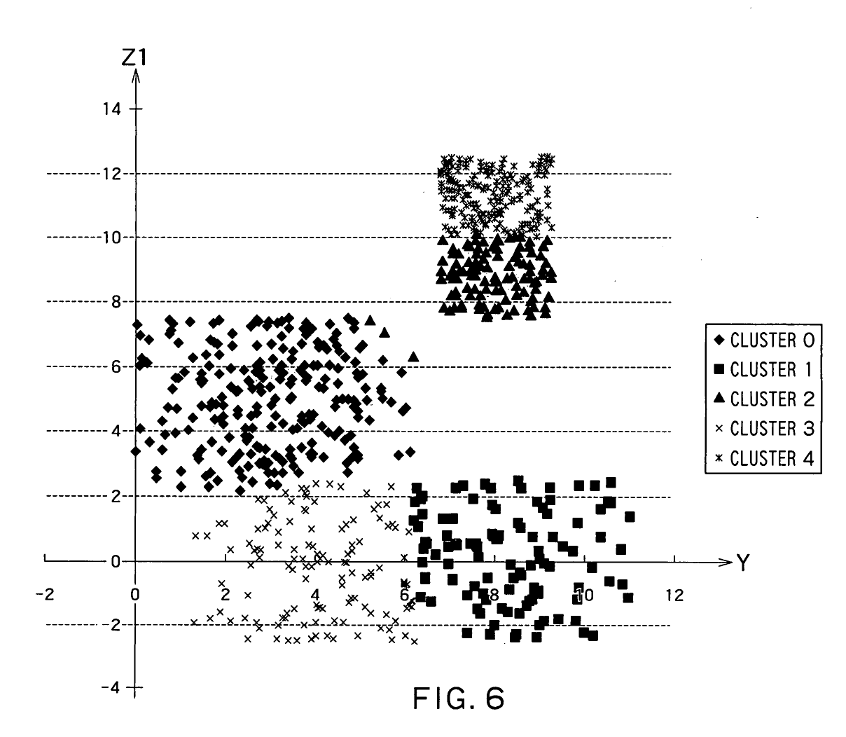

The data dividing unit 2 uses the two-dimensional variable having the effective variable Z1 inputted from the variable selecting unit 5 and the target variable Y to perform clustering again on the data to be analyzed stored in the data storage unit 1. FIG. 6 shows the result of the clustering. In this clustering (re-clustering), the number of clusters as clustering condition, is five as well as in the previous clustering.

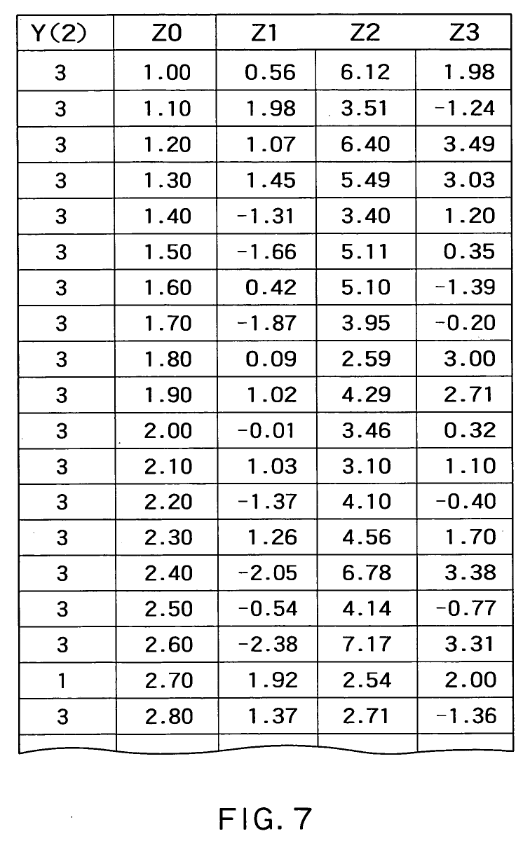

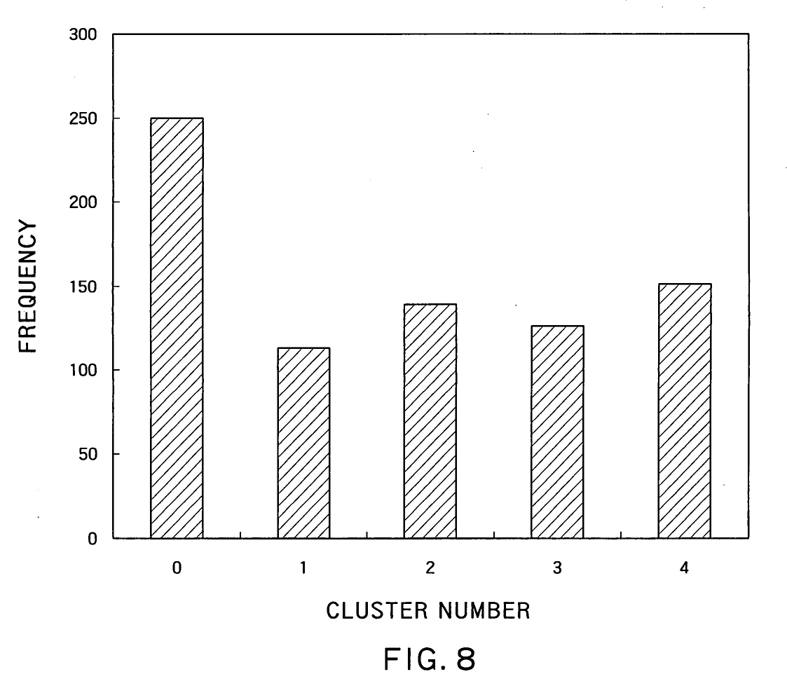

FIG. 7 shows a part of a data table in which the target variables Y in the data table in FIG. 2 is replaced with variables Y(2) indicating the number of cluster obtained by the re-clustering. The data table is generated by the cluster dividing unit 2 and stored in the data storage unit 1. FIG. 8 shows a histogram of the frequency of occurrence of the clusters in FIG. 6 as to the data table in FIG. 7.

The classification rule generating unit 3 regards a variable Y(2) as a target variable and generates a decision tree.

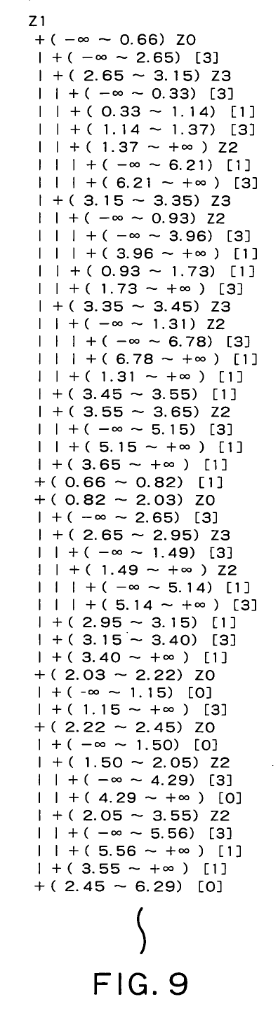

FIG. 9 shows a part of the generated decision tree.

The decision tree in FIG. 9 has about 60 leaf nodes, which is about ¼ of the number of leaf nodes of the decision tree shown in FIG. 5.

Because the root node (variable) of the decision tree in FIG. 9 agrees with the root node of the decision tree in FIG. 5 which was generated just previously (last installment), it is determined that the decision tree in FIG. 9 is similar to the decision tree in FIG. 5 and the process ends. Determination as to whether they are similar to each other may be made on the basis of whether the partial tree from the root node of one decision tree to certain hierarchy, agrees with that of the other decision tree. Alternatively, the process may end if the generated decision tree meets a convergence condition, rather than whether or not the decision trees are similar to each other. The convergence condition may be a condition in which the correct answer ratio of the generated decision tree reaches a threshold value, or may be a condition in which the number of all nodes of the generated decision tree becomes less than or equal to a threshold value. Determination as to whether the process should be continued or not, may be made according to a user input. For example, an input unit through which a user input is performed and a user input storage unit for storing user inputs may be provided in the system shown in FIG. 1 and, if a flag indicating the end of the process is stored in the user input storage unit, the process may be ended.

If the comparison between the decision trees shows that they are not similar to each other (or the decision tree does not converge), the newest decision tree is stored in the classification rule storage unit 4 and the variable selecting unit 5 selects a variable from the stored newest decision tree except previously selected explanation variable(s). The data dividing unit 2 performs again clustering on the basis of a three-dimensional variable having this variable, an already selected variable, and a target variable.

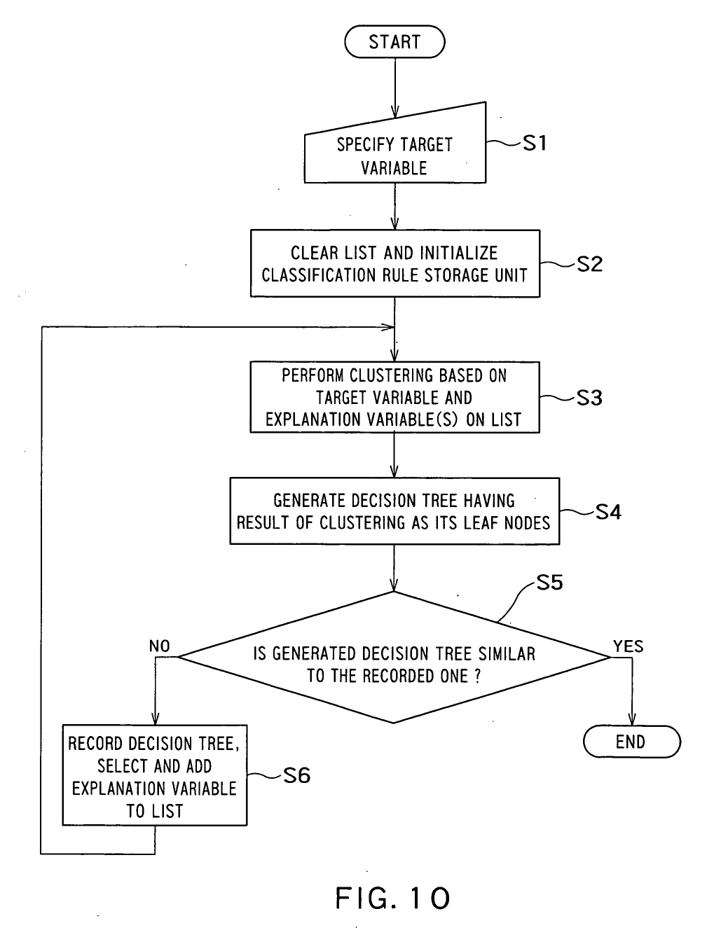

FIG. 10 is a flowchart showing a flow of process performed by the data analysis apparatus shown in FIG. 1.

The data dividing unit 2 determines a target variable from variables included in data to be analyzed, stored in the data storage unit 1 (step S1). The target variable may be determined on the basis of a user input or may be pre-specified. The data dividing unit 2 clears out a list given previously and initializes the classification rule storage unit 4 (step 52).

The data dividing unit 2 performs clustering of data to be analyzed, stored in the data storage unit 1, on the basis of the target variable determined at step S1 and explanation variables on the list (step S3). If no explanation variable is contained yet in the list, the data dividing unit 2 performs clustering based on only the target variable. The data dividing unit 2 adds variables indicating a cluster number to the data to be analyzed to generate a data table, or replaces the target variables of the data to be analyzed with variables indicating a cluster number to generate a data table.

The classification rule generating unit 3 generates a decision tree having cluster numbers as its leaf nodes from the generated data table (step S4). That is, it generates a decision tree for predicting a cluster number from explanation variables.

The classification rule generating unit 3 determines whether or not the generated decision tree is similar to the decision tree last recorded in the classification rule storage unit 4, namely the decision tree just previously generated by the classification rule generating unit 3. If so (YES at step S5), the process ends. Alternatively, determination may be made as to whether the generated decision tree meets a convergence condition and, if so, the process may be ended. As stated earlier, the classification rule generating unit 3 may determine on the basis of a user input whether or not the process should be ended.

On the other hand, if the decision trees do not similar to each other (or a convergence condition is not met) (NO at step S5), the classification rule generating unit 3 stores the generated decision tree in the classification rule storage unit 4 (step S6). The variable selecting unit 5 selects an explanation variable, which is not on the list, from the recorded decision tree and adds it to the list (step S6). Then the process returns to step S3, where clustering is again performed on the basis of all explanation variables on the list and the target variable.

The functions of the components of the data analysis apparatus shown in FIG. 1 may be implemented by causing a computer such as a CPU to execute a program generated by a ordinary programming technique, or may be implemented by hardware. Alternatively, the functions may be implemented by a combination of a program and hardware.

According to the present embodiment, if a target variable is a continuous quantity (numerical value), important variables appearing in a decision tree are used as effective discretization index of the target variable, as has been described. Therefore, a highly readable and simple classification rule can be generated.

Furthermore, according to the present embodiment, the process will end if a generated decision tree is similar to the decision tree previously generated. Therefore, a classification rule can be generated efficiently in a short time.

What is claimed is:

1. A data analysis apparatus comprising:
a database which is a set of records each including plural explanation variables and a target variable;
a cluster generating unit which generates a plurality of clusters based on the target variables of the records;
a determining unit which determines to which cluster each of the records belongs;
a classification rule generating unit which generates a classification rule for predicting a cluster from explanation variables;
a classification rule storage unit which stores the generated classification rule;
an explanation variable selecting unit which selects an explanation variable referred to in the generated classification rule; and
an explanation variable list which stores the selected explanation variable;
wherein the cluster generating unit generates a plurality of clusters based on explanation variables in the records on the explanation variable list and the target variables of the records.

2. The data analysis apparatus according to claim 1, wherein:
the classification rule generating unit generates a decision tree as the classification rule; and
the explanation variable selecting unit selects an explanation variable located at a root of the decision tree or the explanation variable that is most frequently referred to in the decision tree except the explanation variable on the explanation variable list.

3. The data analysis apparatus according to claim 1, comprising a further determining unit which compares a latest classification rule generated by the classification rule generating unit with a classification rule generated by the classification rule generating unit last installment and, if the classification rules meet a similarity condition, determines an end of a process.

4. The data analysis apparatus according to claim 3, wherein:
the classification rule generating unit generates a decision tree as the classification rule; and
the further determining unit determines that the similarity condition is met if the comparison shows that a root node of one of two decision trees agrees with a root node of the other decision tree or if a partial tree of one of the two decision trees agrees with a partial tree of the other decision tree.

5. The data analysis apparatus according to claim 1, further comprising an additional determining unit which determines an end of a process if a classification rule generated by the classification rule generating unit meets a convergence condition.

6. The data analysis apparatus according to claim 5, wherein:
the classification rule generating unit generates a decision tree as the classification rule; and
the additional determining unit determines that the convergence condition is met if a correct answer ratio of the decision tree is greater than or equal to a threshold value or if the number of the nodes of the decision tree is less than or equal to a threshold value.

7. A data analysis program for inducing a computer to execute:
reading out, from a database which is a set of records each including plural explanation variables and a target variable, the target variables of the records;
generating a first plurality of clusters based on the read target variables of the records;
determining to which cluster each record belongs;
generating a classification rule for predicting a cluster from explanation variables;
storing the generated classification rule;
selecting an explanation variable referred to in the generated classification rule;
storing the selected explanation variable in an explanation variable list; and
generating a second plurality of clusters based on explanation variables in the records on the explanation variable list and the target variables of the records.

8. The data analysis program according to claim 7, wherein after generating the second plurality of clusters, the determining, the generating the classification rule, the storing the generated classification rule, the selecting the explanation variable, the storing the explanation variable, and the generating the second plurality of clusters are repeated in that order.

9. The data analysis program according to claim 7, for inducing the computer to execute:
generating a decision tree as the classification rule; and
selecting an explanation variable located at a root of the decision tree or the explanation variable that is most frequently referred to in the decision tree except the explanation variable on the explanation variable list.

10. The data analysis program according to claim 7, for inducing the computer further to execute:
comparing a latest generated classification rule with a classification rule generated last installment; and
determining an end of a process if the classification rules meet a similarity condition.

11. The data analysis program according to claim 10, for inducing the computer to execute:
generating a decision tree as the classification rule; and
determining that the similarity condition is met if the comparison shows that a root node of one of two decision trees agrees with a root node of the other decision tree or if a partial tree of one of the two decision trees agrees with a partial tree of the other decision tree.

12. The data analysis program according to claim 7, further comprising
determining an end of a process if a classification rule generated meets a convergence condition.

13. The data analysis program according to claim 12, wherein:
generating a decision tree as the classification rule; and
determining that the convergence condition is met if a correct answer ratio of the decision tree is greater than or equal to a threshold value or if the number of the nodes of the decision tree is less than or equal to a threshold value.

14. A data analysis method comprising:
reading out, from a database which is a set of records each including plural explanation variables and a target variable, the target variables of the records;
generating a first plurality of clusters based on the read target variables of the records;
determining to which cluster each record belongs;
generating a classification rule for predicting a cluster from explanation variables;
storing the generated classification rule;
selecting an explanation variable referred to in the generated classification rule;
storing the selected explanation variable in an explanation variable list; and
generating a second plurality of clusters based on explanation variables in the records on the explanation variable list and the target variables of the records.

15. The data analysis method according to claim 14, wherein after generating the second plurality of clusters, the determining, the generating the classification rule, the storing the generated classification rule, the selecting the explanation variable, the storing the explanation variable, and the generating the second plurality of clusters are repeated in that order.

16. The data analysis method according to claim 14, comprising:
generating a decision tree as the classification rule; and
selecting an explanation variable located at a root of the decision tree or the explanation variable that is most frequently referred to in the decision tree except the explanation variable on the explanation variable list.

17. The data analysis method according to claim 14, further comprising:
comparing a latest generated classification rule with a classification rule generated last installment; and
determining an end of a process if the classification rules meet a similarity condition.

18. The data analysis method according to claim 17, including:
generating a decision tree as the classification rule; and
determining that the similarity condition is met if the comparison shows that a root node of one of two decision trees agrees with a root node of the other decision tree or if a partial tree of one of the two decision trees agrees with a partial tree of the other decision tree.

19. The data analysis method according to claim 14, further comprising
determining an end of a process if a classification rule generated meets a convergence condition.

20. The data analysis method according to claim 19, comprising:
generating a decision tree as the classification rule; and
determining that the convergence condition is met if a correct answer ratio of the decision tree is greater than or equal to a threshold value or if the number of the nodes of the decision tree is less than or equal to a threshold value.
